(19) United States
(12) Patent Application Publication
(10) Pub. No.: US 2007/0057573 A1
(43) Pub. Date: Mar. 15, 2007

(54) Traction control apparatus and traction controlling method for vehicle

(76) Inventor: Yoichi Abe, Nagoya-shi (JP)

Correspondence Address: BUCHANAN, INGERSOLL & ROONEY PC, POST OFFICE BOX 1404, ALEXANDRIA, VA, 22313-1404, US

(21) Appl. No.: 11/512,079

(22) Filed: Aug. 30, 2006

(30) Foreign Application Priority Data
Sep. 9, 2005 (JP) 2005-262482

(51) Int. Cl. B60T 8/60

(52) U.S. Cl. 303/148

(57) ABSTRACT

A traction control apparatus for a vehicle includes a hydraulic circuit, a hydraulic pressure changing unit, a braking unit, a slip amount detection unit, a control amount computing unit, and a control unit. The hydraulic pressure changing unit changes a brake fluid pressure in the hydraulic circuit. The braking unit applies a braking force to the drive wheel based on the brake fluid pressure in the hydraulic circuit changed by the hydraulic pressure changing unit. The slip amount detection unit detects a slip amount of the drive wheel. The control amount computing unit computes a control amount for changing the brake fluid pressure in the hydraulic circuit such that, during a period from when the slip amount of the drive wheel detected by the slip amount detection unit surpasses a predetermined slip amount threshold value to when the slip amount falls to or below the slip amount threshold value, the brake fluid pressure reaches a maximum pressure corresponding to the slip amount and thereafter falls from the maximum pressure to a minimum pressure. The control unit controls the hydraulic pressure changing unit based on the control amount computed by the control amount computing unit.

### CROSS REFERENCE TO RELATED APPLICATIONS

This application is based on and claims priority under 35 U.S.C. sctn. 119 with respect to Japanese Patent Application No. 2005-262482 filed on Sep. 9, 2005, the entire content of which is incorporated herein by reference.

### BACKGROUND OF THE INVENTION

The present invention relates to a vehicle traction control apparatus and a vehicle traction controlling method that prevent a drive wheel from acceleration slip when the vehicle is traveling.

In general, when a vehicle is traveling, depression of the accelerator pedal by the driver can cause acceleration slip of a drive wheel, which is driven by the power of the engine (for example, left and right front wheels in the case of a front-wheel-drive vehicle). Such acceleration slip of the drive wheel degrades the driving stability of the vehicle. Accordingly, Japanese Laid-Open Patent Publication No. 2005-35441 discloses a vehicle traction control apparatus and a vehicle traction controlling method, which suppress acceleration slip of a drive wheel.

The traction control apparatus disclosed in Japanese Laid-Open Patent Publication No. 2005-35441 includes a hydraulic circuit for applying braking force to a drive wheel. A proportional differential pressure valve including a proportional electromagnetic valve and a relief valve is provided in a section of the hydraulic circuit closest to a master cylinder. When the amount of slip of a drive wheel exceeds a slip amount threshold value, the drive wheel is judged to be slipping due to acceleration. In this case, the proportional differential pressure valve is closed, and a pump located on the hydraulic circuit is activated, so that brake fluid is supplied from a reservoir to increase the brake fluid pressure in the hydraulic circuit. Braking force corresponding to the increase in the brake fluid pressure keeps being applied to the drive wheel so that the rotation speed of the drive wheel is reduced. As a result, the acceleration slip is suppressed.

The traction control apparatus disclosed in Japanese Laid-Open Patent Publication No. 2005-35441 continues increasing the brake fluid pressure (corresponding to the braking force applied to the drive wheel) in the hydraulic circuit as long as acceleration slip is occurring to a greater or lesser degree regardless whether changes in the amount of slip is increasing or decreasing. Therefore, there can be a case where the brake fluid pressure in the hydraulic circuit has not reached a maximum value when the amount of slip of the drive wheel is maximized as shown in FIG. 5. That is, there are cases where the brake fluid pressure remains low even if the brake fluid pressure needs to be set relatively high to deal with an increase in the slip amount of the drive wheel. On the other hand, there can also be a case where the brake fluid pressure in the hydraulic circuit reaches the maximum value when the amount of slip of the drive wheel is not more than the slip amount threshold value as shown in FIG. 5. That is, there are cases where the brake fluid pressure is high even if the brake fluid pressure in the hydraulic circuit can be set relatively low because of a decrease in the amount of slip of the drive wheel.

### SUMMARY OF THE INVENTION

Accordingly, it is an objective of the present invention to provide a vehicle traction control apparatus and a vehicle traction controlling method that are capable of appropriately changing brake fluid pressure in a hydraulic circuit in accordance with increase and decrease in the amount of slip of a drive wheel.

To achieve the foregoing objectives and in accordance with one aspect of the present invention, a traction control apparatus for a vehicle that has a drive wheel is provided. The apparatus includes a hydraulic circuit, a hydraulic pressure changing unit, a braking unit, a slip amount detection unit, a control amount computing unit, and a control unit. The hydraulic pressure changing unit changes a brake fluid pressure in the hydraulic circuit. The braking unit applies a braking force to the drive wheel based on the brake fluid pressure in the hydraulic circuit changed by the hydraulic pressure changing unit. The slip amount detection unit detects a slip amount of the drive wheel. The control amount computing unit computes a control amount for changing the brake fluid pressure in the hydraulic circuit such that, during a period from when the slip amount of the drive wheel detected by the slip amount detection unit surpasses a predetermined slip amount threshold value to when the slip amount falls to or below the slip amount threshold value, the brake fluid pressure reaches a maximum pressure corresponding to the slip amount and thereafter falls from the maximum pressure to a minimum pressure. The control unit controls the hydraulic pressure changing unit based on the control amount computed by the control amount computing unit.

In accordance with another aspect of the present invention, a traction control method for a vehicle that has a drive wheel is provided. The method includes: detecting a slip amount of the drive wheel; changing a brake fluid pressure in a hydraulic circuit such that, during a period from when the detected slip amount of the drive wheel surpasses a predetermined slip amount threshold value to when the slip amount falls to or below the slip amount threshold value, the brake fluid pressure reaches a maximum pressure corresponding to the slip amount and thereafter falls from the maximum pressure to a minimum pressure; and applying a braking force to the drive wheel based on the changed brake fluid pressure in the hydraulic circuit.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram showing a vehicle traction control apparatus according to one embodiment of the present invention;

FIG. 2 is a block diagram showing a braking force applying mechanism of the traction control apparatus shown in FIG. 1;

FIG. 3 is a flowchart showing an acceleration slip suppression process routine in the embodiment;

FIG. 4A is a timing chart showing increases and decreases in the amount of slip of front wheels in the embodiment;

FIG. 4B is a timing chart showing increases and decreases in a first instruction hydraulic pressure and a second instruction hydraulic pressure in the embodiment;

FIG. 4C is a timing chart showing increases and decreases in an instruction hydraulic pressure in the embodiment; and

FIG. 5 is a timing chart showing increases and decreases in the amount of slip of drive wheels, and increases and decreases in brake fluid pressure in a traction control apparatus disclosed in Japanese Laid-Open Patent Publication No. 2005-35441.

### DETAILED DESCRIPTION OF THE PREFERRED EMBODIMENTS

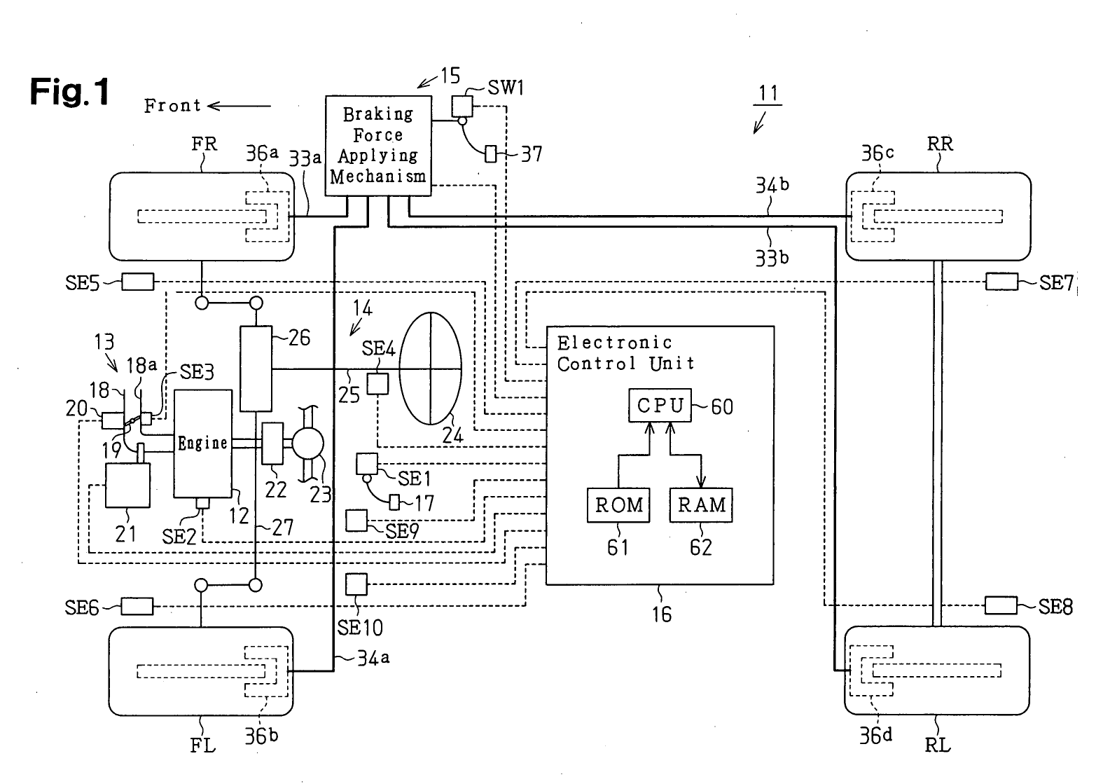

One embodiment of the present invention will now be described with reference to FIGS. 1 to 4. Hereafter, the advancing direction of a vehicle is referred to as a forward direction of the vehicle. Also, unless otherwise specified, a lateral direction coincides with the lateral direction with respect to the vehicle advancing direction.

As shown in FIG. 1, a traction control apparatus 11 according to the present embodiment is mounted on a front-wheel drive vehicle, in which front wheels FR, FL function as drive wheels among a plurality of wheels (in this embodiment four wheels: a right front wheel FR, a left front wheel FL, a right rear wheel RR, and a left rear wheel RL). The traction control apparatus 11 includes a power transmission mechanism 13, a front wheel steering mechanism 14, and a braking force applying mechanism 15. The power transmission mechanism 13 transmits driving force generated in an engine 12 functioning as a driving source to the front wheels FR, FL. The front wheel steering mechanism 14 steers the front wheels FR, FL, or steered wheels. The braking force applying mechanism 15 applies braking force to the wheels FL, FR, RL, RR. Also, the traction control apparatus 11 includes an electronic control unit (ECU) 16 that appropriately controls the mechanisms 13, 14, 15 in accordance with the driving state of the vehicle. The engine 12 generates the driving force, the magnitude of which corresponds to the amount of depression of an accelerator pedal 17 by the driver of the vehicle.

The power transmission mechanism 13 includes a throttle valve actuator (for example, a DC motor) 20 and a fuel injection device 21. The throttle valve actuator 20 controls the opening degree of a throttle valve 19 that varies a cross-sectional area of an intake passage 18a in an intake pipe 18. The fuel injection device 21 has injectors that inject fuel to areas in the vicinity of intake ports (not shown) of the engine 12. The power transmission mechanism 13 also includes a transmission 22 coupled to an output shaft of the engine 12, and a differential gear 23 that appropriately distributes the driving force transmitted through the transmission 22 and supplies the force to the front wheels FL, FR. Further, the power transmission mechanism 13 includes an accelerator pedal position sensor SE1 that detects the depression degree of the accelerator pedal 17, a rotation speed sensor SE2 for detecting the rotation speed of the engine 12, and a throttle valve opening degree sensor SE3 for detecting the opening degree of the throttle valve 19.

The front wheel steering mechanism 14 includes a steering wheel 24, a steering shaft 25 to which the steering wheel 24 is fixed, a steering actuator 26 to which the steering shaft 25 is coupled. The front wheel steering mechanism 14 also includes tie rods and a link mechanism 27. The tie rods are movable in the lateral direction of the vehicle by the steering actuator 26. The link mechanism 27 includes a linkage that steers the front wheels FL and FR according to movement of the tie rods. Further, the front wheel steering mechanism 14 includes a turned angle sensor SE4 that detects the turned angle of the steering wheel 24.

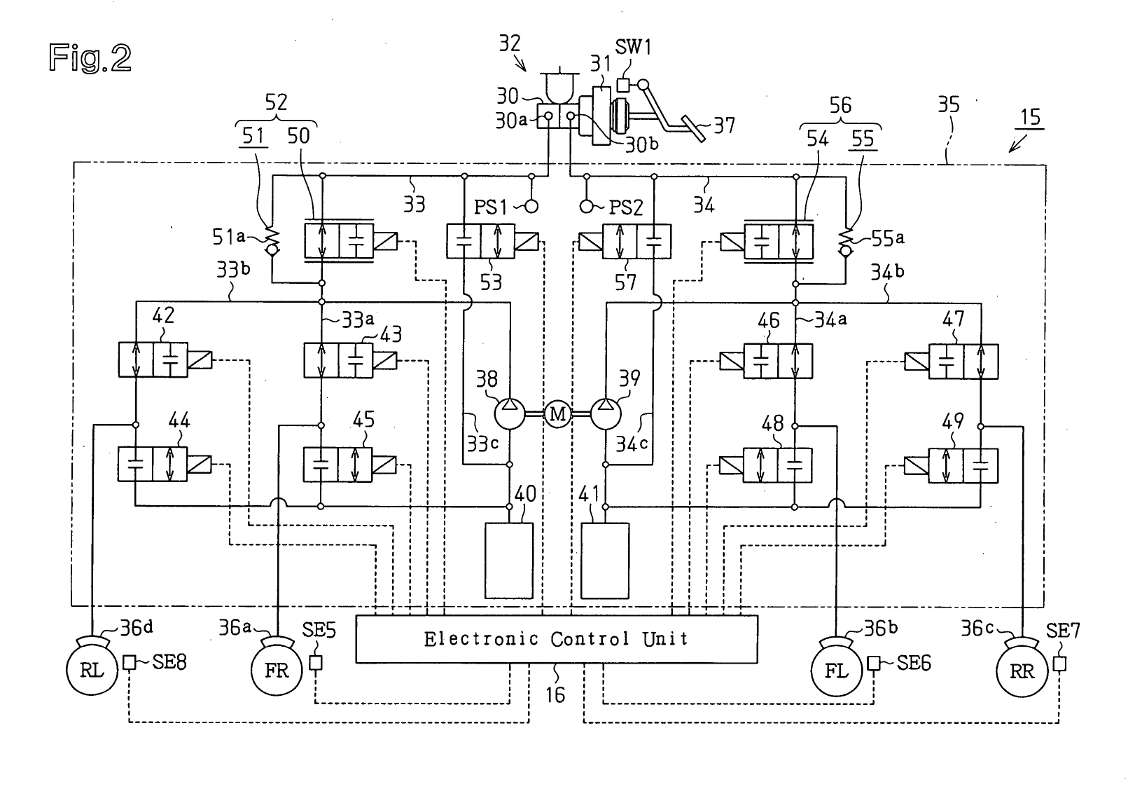

The braking force applying mechanism 15 will now be described with reference to FIG. 2.

As shown in FIG. 2, the braking force applying mechanism 15 includes a hydraulic pressure generating device 32 having a master cylinder 30 and a booster 31, and a hydraulic pressure controlling device 35 (alternate long and two short dashes line in FIG. 2) having first and second hydraulic circuits 33, 34. The hydraulic circuits 33, 34 are connected to the hydraulic pressure generating device 32. The first hydraulic circuit 33 is connected to wheel cylinders 36a 36d. The second hydraulic circuit 34 is connected to wheel cylinders 36b, 36c. The wheel cylinder 36a corresponds to the right front wheel FR, and the wheel cylinder 36b corresponds to the left front wheel FL. Also, the wheel cylinder 36c corresponds to the right rear wheel RR, and the wheel cylinder 36d corresponds to the left rear wheel RL. In this embodiment, the wheel cylinders 36a, 36b for the front wheels FR, FL function as a braking unit (braking means) that applies braking force to the drive wheels (the front wheels FR, FL).

The hydraulic pressure generating device 32 includes a brake pedal 37. When the brake pedal 37 is depressed by the driver, the master cylinder 30 and the booster 31 of the hydraulic pressure generating device 32 are activated. The master cylinder 30 has two output ports 30a, 30b. The output port 30a is connected to the first hydraulic circuit 33, and the output port 30b is connected to the second hydraulic circuit 34. Further, the hydraulic pressure generating device 32 includes a brake switch SW1, which sends a signal to the electronic control unit 16 when the brake pedal 37 is depressed.

The hydraulic pressure controlling device 35 includes a pump 38 for increasing the brake fluid pressure in the first hydraulic circuit 33, a pump 39 for increasing the brake fluid pressure in the second hydraulic circuit 34, and a motor M for simultaneously driving the pumps 38, 39. Reservoirs 40, 41 for storing brake fluid are provided on the hydraulic circuits 33, 34, respectively. Brake fluid in the reservoirs 40, 41 is supplied to the hydraulic circuits 33, 34 in response to the activation of the pumps 38, 39. Further, the hydraulic circuits 33, 34 have hydraulic pressure sensors PS1, PS2 for detecting the brake fluid pressure in the master cylinder 30, respectively.

The first hydraulic circuit 33 has a right-front-wheel path 33a and a left-rear-wheel path 33b. The right-front-wheel path 33a is connected to the wheel cylinder 36a corresponding to the right front wheel FR. The left-rear-wheel path 33b is connected to the wheel cylinder 36d corresponding to the left rear wheel RL. A normally open electromagnetic valve 42 and a normally closed electromagnetic valve 44 are provided on the left-rear-wheel path 33b. A normally open electromagnetic valve 43 and a normally closed electromagnetic valve 45 are provided on the right-front-wheel path 33a.

Likewise, the second hydraulic circuit 34 has a left-front-wheel path 34a and a right-rear-wheel path 34b. The left-front-wheel path 34a is connected to the wheel cylinder 36b corresponding to the left front wheel FL. The right-rear-wheel path 34b is connected to the wheel cylinder 36c corresponding to the right rear wheel RR. A normally open electromagnetic valve 46 and a normally closed electromagnetic valve 48 are provided on the left-front-wheel path 34a. A normally open electromagnetic valve 47 and a normally closed electromagnetic valve 49 are provided on the right-rear-wheel path 34b.

A normally open proportional electromagnetic valve 50 and a relief valve 51 parallel to the proportional electromagnetic valve 50 are provided in a section of the first hydraulic circuit 33 that is closer to the master cylinder 30 than the branched portion of the paths 33a, 33b. The proportional electromagnetic valve 50 and the relief valve 51 form a proportional differential pressure valve 52. In response to control by the electronic control unit 16, the proportional differential pressure valve 52 generates a hydraulic pressure difference (difference of the brake fluid pressure) between a section of the first hydraulic circuit 33 closer to the master cylinder 30 than the proportional differential pressure valve 52 and a section of the first hydraulic circuit 33 closer to the wheel cylinders 36a, 36d than the proportional differential pressure valve 52. The maximum value of the hydraulic pressure difference is determined based on the urging force of a spring 51a of the relief valve 51. The first hydraulic circuit 33 includes a branch hydraulic circuit 33c, which is branched from a section between the reservoir 40 and the pump 38 toward the master cylinder 30. A normally closed electromagnetic valve 53 is provided in the branch hydraulic circuit 33c.

A normally open proportional electromagnetic valve 54 and a relief valve 55 parallel to the proportional electromagnetic valve 54 are provided in a section of the second hydraulic circuit 34 that is closer to the master cylinder 30 than the branched portion of the paths 34a, 34b. The proportional electromagnetic valve 54 and the relief valve 55 form a proportional differential pressure valve 56. In response to control by the electronic control unit 16, the proportional differential pressure valve 56 generates a hydraulic pressure difference (difference of the brake fluid pressure) between a section of the second hydraulic circuit 34 closer to the master cylinder 30 than the proportional differential pressure valve 56 and a section of the second hydraulic circuit 34 closer to the wheel cylinders 36b, 36c than the proportional differential pressure valve 52. The maximum value of the hydraulic pressure difference is determined based on the urging force of a spring 55a of the relief valve 55. The second hydraulic circuit 34 includes a branch hydraulic circuit 34c, which is branched from a section between the reservoir 41 and the pump 39 toward the master cylinder 30. A normally closed electromagnetic valve 57 is provided in the branch hydraulic circuit 34c.

Changes in the brake fluid pressure in each of the wheel cylinders 36a to 36d will now be described in cases where the solenoid coils of the electromagnetic valves 42 to 49 are energized and de-energized. In the following description, the proportional electromagnetic valves 50, 54 are assumed to be closed, and the electromagnetic valves 53, 57 in the branch hydraulic circuits 33c, 34c are assumed to be closed.

When all the solenoid coils of the electromagnetic valves 42 to 49 are de-energized, the normally open electromagnetic valves 42, 43, 46, 47 remain open, and the normally closed electromagnetic valves 44, 45, 48, 49 remain closed. Therefore, while the pumps 38, 39 are operating, the brake fluid in the reservoirs 40, 41 flows to the wheel cylinders 36a to 36d through the paths 33a, 33b, 34a, 34b, so that the brake fluid pressure in the wheel cylinders 36a to 36d is increased.

On the other hand, when all the solenoid coils of the electromagnetic valves 42 to 49 are energized, the normally open electromagnetic valves 42, 43, 46, 47 are closed, and the normally closed electromagnetic valves 44, 45, 48, 49 are opened. Therefore, the brake fluid flows from the wheel cylinders 36a to 36d to the reservoirs 40, 41 through the paths 33a, 33b, 34a, 34b, so that the brake fluid pressure in the wheel cylinders 36a to 36d is lowered.

When the solenoid coils of only the normally open electromagnetic valves 42, 43, 46, 47 among the electromagnetic valves 42 to 49 are energized, all the electromagnetic valves 42 to 49 are closed. Therefore, the flow of brake fluid through the paths 33a, 33b, 34a, 34b is limited. As a result, the level of the brake fluid pressure in the wheel cylinders 36a to 36d is maintained.

As shown in FIG. 1, the electronic control unit 16 includes a digital computer and drive circuits (not shown) for driving various devices. The digital computer includes a CPU 60 functioning as a control unit (control means), a ROM 61, and a RAM 62. The ROM 61 stores a control program for controlling the hydraulic pressure controlling device 35 (the motor M, the electromagnetic valves 42 to 49, 53, and 57, and the proportional electromagnetic valves 50, 54), and a threshold value (a slip amount threshold value, which is discussed below). The RAM 62 stores various types of information, which is rewritten as necessary during the operation of the traction control apparatus 11.

An input interface (not shown) of the electronic control unit 16 is connected to the brake switch SW1, the hydraulic pressure sensors PS1, PS2, the accelerator pedal position sensor SE1, the rotation speed sensor SE2, the throttle valve opening degree sensor SE3, and the turned angle sensor SE4. Further, the input interface is connected to wheel speed sensors SE5, SE6, SE7, SE8 for detecting the speed of the wheels FL, FR, RL, RR, a lateral G sensor SE9 for detecting lateral acceleration (lateral G) that is actually applied to the vehicle, and a yaw rate sensor SE10 for detecting yaw rate that is actually applied to the vehicle. That is, the CPU 60 receives signal's from the brake switch SW1, the hydraulic pressure sensors PS1, PS2, and the sensors SE1 to SE10.

An output interface (not shown) of the electronic control unit 16 is connected to the motor M for driving the pumps 38, 39, the electromagnetic valves 42 to 49, 53, and 57, and the proportional electromagnetic valve 50, 54. Based on signals from the switch SW1 and the sensors PS1, PS2, and SE1 to SE10, the CPU 60 separately controls the operation of the motor M, the electromagnetic valves 42 to 49, 53, and 57, and the proportional electromagnetic valves 50, 54.

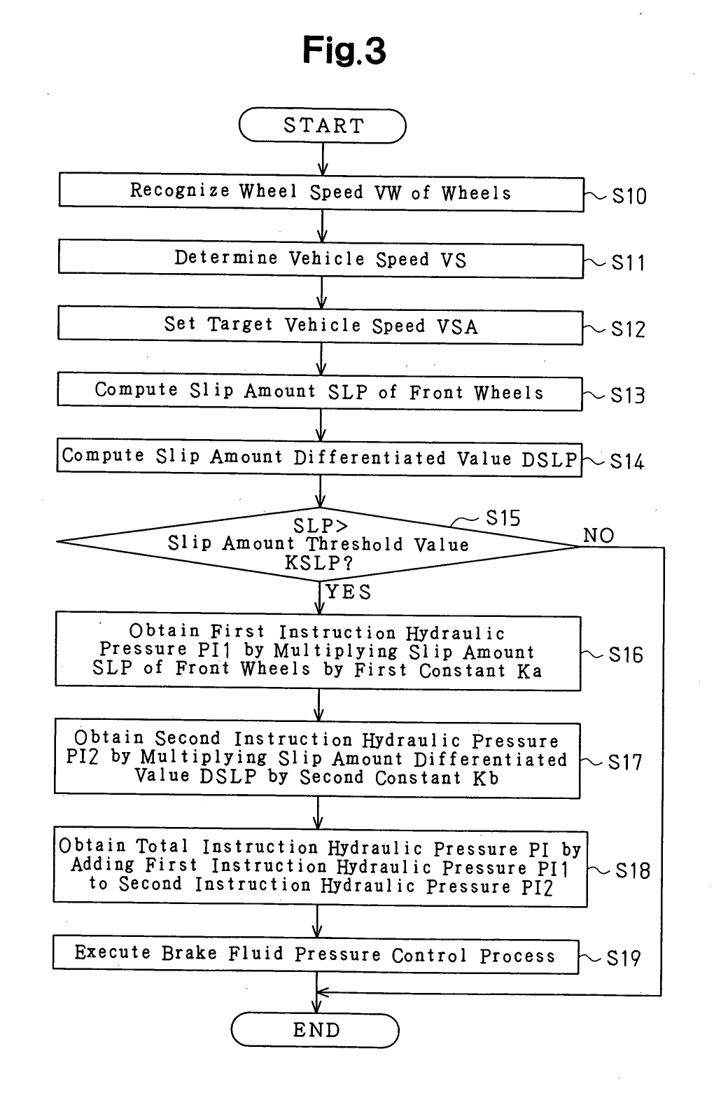

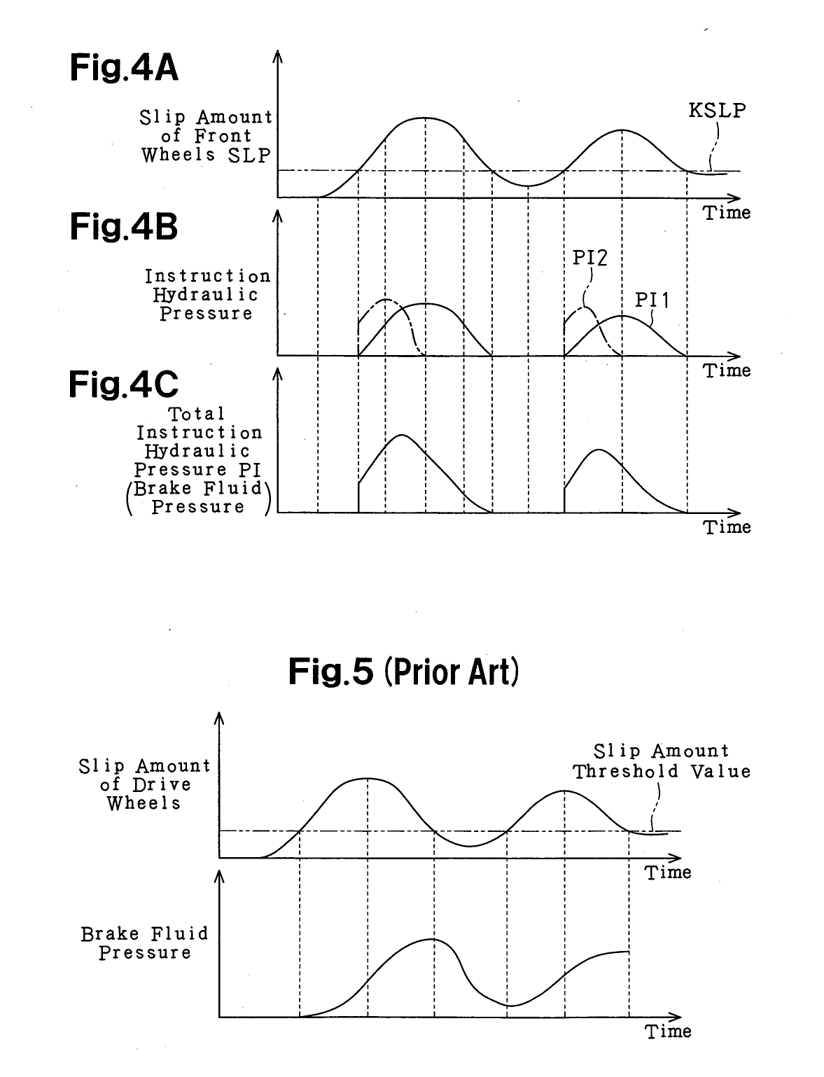

Next, among control process routines executed by the CPU 60, an acceleration slip suppression process routine, which is executed when the accelerator pedal 17 is depressed while the vehicle is traveling, will be described with reference to a flow chart shown in FIG. 3 and timing charts shown in FIGS. 4A, 4B, and 4C.

The CPU 60 executes the acceleration slip suppression process routine at predetermined intervals. In the acceleration slip suppression process routine, the CPU 60 recognizes the wheel speed VW of each of the wheels FL, FR, RL, RR based on signals from the wheel speed sensors SE5 to SE8 of the wheels FL, FR, RL, RR (step S10). Among the wheel speeds VW of the wheels FL, FR, RL, RR recognized at step S10, the CPU 60 determines the wheel speed VW of the rear wheels RL, RR, which are not drive wheels, as a vehicle speed VS (step S11). Subsequently, assuming that the vehicle is accelerating in response to depression of the accelerator pedal 17 by the driver, the CPU 60 adds a predetermined value (for example, 2 km/h) to the vehicle speed VS determined at step S11 and sets the resultant as a target vehicle speed VSA (step S12). That is, if the value of the vehicle speed VS set at step S11 is 100, the CPU 60 sets the target vehicle speed VSA to 100+α (for example, 102).

Based on the wheel speed VW of the front wheels FR, FL, or the drive wheels, recognized at step S10, and the target vehicle speed VSA set at step S12, the CPU 60 computes the amount of slip SLP of the front wheels FR, FL (step S13). The slip amount SLP of the front wheels FR, FL is a value obtained by subtracting the target vehicle speed VSA from the wheel speed VW of the front wheels FR, FL. In this respect, the wheel speed sensors SE5 to SE8 and the CPU 60 function as a slip amount detection unit (slip amount detection means) that detects the acceleration slip amount SLP of the front wheels (drive wheels) FR, FL.

Subsequently, the CPU 60 differentiates the slip amount SLP of the front wheels FR, FL computed at step S13, thereby obtaining slip amount differentiated value DSLP related to the front wheels FR, FL(step S14). That is, the CPU 60 computes the rate of change of the slip amount SLP of the front wheels FR, FL. Then, the CPU 60 determines whether the slip amount SLP of the front wheels FR, FL computed at step S13 are greater than a slip amount threshold value KSLP (step S15). If the decision outcome is negative (SLP≦KSLP), the CPU 60 determines that the front wheels FR, FL are not slipping due to acceleration, and ends the acceleration slip suppression process routine. On the other hand, if the decision outcome is positive (SLP>KSLP), the CPU 60 determines that the front wheels FR, FL are slipping due to acceleration, and proceeds to step S16.

At step S16, the CPU 60 multiplies the slip amount SLP of the front wheels FR, FL, which are slipping due to acceleration, by a first constant (slip amount constant) Ka, thereby obtaining a first instruction hydraulic pressure (first control amount) PI1 of the brake fluid pressure, which is proportionate to the slip amount SLP of the front wheels FR, FL. The first constant Ka is a value for converting the slip amount SLP of the front wheels FR, FL into control amount of the brake fluid pressure in the hydraulic circuits 33, 34, and is set in advance through experiments and simulations.

If the slip amount SLP of the front wheels FR, FL, or the drive wheels, changes as shown in FIG. 4A, the first instruction hydraulic pressure PI1 computed at step S16 changes as shown by solid line in FIG. 4B. That is, the first instruction hydraulic pressure PI1 changes at the same timing as the slip amount SLP of the front wheels FR, FL in the case where the slip amount SLP of the front wheels FR, FL exceeds the slip amount threshold value KSLP. When the slip amount SLP of the front wheels FR, FL increases, the first instruction hydraulic pressure PI1 increases, and when the slip amount SLP of the front wheels FR, FL decreases, the first instruction hydraulic pressure PI1 decreases. When the slip amount SLP of the front wheels FR, FL is equal to or less than the slip amount threshold value KSLP, the first instruction hydraulic pressure PI1 is substantially set to zero.

Subsequently, the CPU 60 multiplies the slip amount differentiated value DSLP related to the front wheels FR, FL, which are slipping due to acceleration, by a second constant (slip amount differentiated value constant) Kb, thereby obtaining a second instruction hydraulic pressure (second control amount) PI2, which is proportionate to the rate of change of the slip amount SLP of the front wheels FR, FL, or the slip amount differentiated value DSLP (step S17). The second constant Kb is a value for converting the rate of change of the slip amounts SLP of the front wheels FR, FL into control amount of the brake fluid pressure in the hydraulic circuits 33, 34, and is set in advance through experiments and simulations.

If the slip amount SLP of the front wheels FR, FL, or the drive wheels, changes as shown in FIG. 4A, the second instruction hydraulic pressure PI2 computed at step S17 changes as shown by an alternate long and short dash line in FIG. 4B. That is, in the case where the slip amount SLP of the front wheels FR, FL exceeds the slip amount threshold value KSLP, the second instruction hydraulic pressure PI2 increases when the rate of change of the slip amount of the front wheels FR, FL is great, and decreases when the rate of change of the slip amount SLP is small. When the slip amount differentiated value DSLP has a negative value, the second instruction hydraulic pressure PI2 is substantially set to zero. When the slip amount SLP of the front wheels FR, FL is equal to or less than the slip amount threshold value KSLP, the second instruction hydraulic pressure PI2 is substantially set to zero.

The CPU 60 adds the first instruction hydraulic pressure PI1 computed at step S16 to the second instruction hydraulic pressure PI2 computed at step S17, thereby obtaining a total instruction hydraulic pressure (control amount) PI (step S18). In this respect, when the slip amount SLP of the front wheels (drive wheels) FR, FL exceeds the slip amount threshold value KSLP, the CPU 60 functions as a control amount computing unit (control amount computing means) for setting the total instruction hydraulic pressure (control amount) PI. Subsequently, to apply braking force to the front wheels FR, FL, the CPU 60 executes a brake fluid pressure control process such that the brake fluid pressure in the hydraulic circuits 33, 34 (that is, in the right-front-wheel path 33a and the left-front-wheel path 34a) becomes equal to the total instruction hydraulic pressure PI computed at step S18 (step S19).

In this case, if the slip amount SLP of the front wheels FR, FL changes as shown in FIG. 4A, the total instruction hydraulic pressure PI changes as shown in FIG. 4C. The total instruction hydraulic pressure PI becomes equal to the sum of the first instruction hydraulic pressure PI1 and the second instruction hydraulic pressure PI2. Therefore, when the slip amount SLP of the front wheels FR, FL exceeds the slip amount threshold value KSLP, the total instruction hydraulic pressure PI starts increasing. After the slip amount differentiated value DSLP reaches the maximum value and before the slip amount SLP of the front wheels FR, FL reaches the maximum value, the total instruction hydraulic pressure PI reaches the maximum pressure. Then, the total instruction hydraulic pressure PI decreases from the maximum pressure. When the slip amount SLP of the front wheels FR, FL is equal to the slip amount threshold value KSLP, the total instruction hydraulic pressure PI becomes 0 atmospheric pressure, which is the minimum pressure. Thereafter, when the slip amount SLP of the front wheels starts increasing, the total instruction hydraulic pressure PI also increases.

When increasing the braking force of the wheel cylinder 36a applied to the right front wheel FR, the CPU 60 first energizes the electromagnetic valve 42 for maintaining the brake fluid pressure in the wheel cylinder 36d for the left rear wheel RL, and activates the pump 38 (the motor M). Next, the CPU 60 controls the proportional differential pressure valve 52 such that the brake fluid pressure difference between a section of the first hydraulic circuit 33 closer to the master cylinder 30 than the proportional differential pressure valve 52 and a section of the first hydraulic circuit 33 closer to the wheel cylinder 36a than the proportional differential pressure valve 52 becomes equal to the total instruction hydraulic pressure PI computed at step S18. Since the electromagnetic valves 43, 45 are not energized, the brake fluid pressure in the right-front-wheel path 33a (the wheel cylinder 36a) is increased to the total instruction hydraulic pressure PI. As a result, the braking force applied to the right front wheel FR by the wheel cylinder 36a is increased.

Likewise, when increasing the braking force of the wheel cylinder 36b applied to the left front wheel FL, the CPU 60 first energizes the electromagnetic valve 47 for maintaining the brake fluid pressure in the wheel cylinder 36c for the right rear wheel RR, and activates the pump 39 (the motor M). Next, the CPU 60 controls the proportional differential pressure valve 56 such that the brake fluid pressure difference between a section of the second hydraulic circuit 34 closer to the master cylinder 30 than the proportional differential pressure valve 56 and a section of the second hydraulic circuit 34 closer to the wheel cylinder 36b than the proportional differential pressure valve 56 becomes equal to the total instruction hydraulic pressure PI computed at step S18. Since the electromagnetic valves 46, 48 are not energized, the brake fluid pressure in the left-front-wheel path 34a (the wheel cylinder 36b) is increased to the total instruction hydraulic pressure PI. As a result, the braking force applied to the left front wheel FL by the wheel cylinder 36b is increased. Therefore, in this embodiment, the pumps 38, 39, the motor M, and the proportional differential pressure valves 52, 56 function as a hydraulic pressure changing unit (hydraulic pressure changing means) that changes the brake fluid pressure in the hydraulic circuits 33, 34.

After executing the above process, the CPU 60 ends the drive slip suppression process routine.

The vehicle traction control method according to the present embodiment will now be described. The following discussion is based on the assumption that the right front wheel FR of the front wheels FR, FL slips due to acceleration.

When the vehicle travels based on depression of the accelerator pedal 17 by the driver, the right front wheel FR, which is a drive wheel, can start slipping, and the slip amount of the front wheel FR can surpass the slip amount threshold value KSLP (the slip amount SLP>the slip amount threshold value KSLP). Then, the first instruction hydraulic pressure PI1 and the second instruction hydraulic pressure PI2 are computed, and the total instruction hydraulic pressure PI is computed. Then, the braking force applying mechanism 15 is activated based on the total instruction hydraulic pressure PI.

That is, the electromagnetic valve 42 on the left-rear-wheel path 33b is energized to maintain the brake fluid pressure in the wheel cylinder 36d for the left rear wheel RL, and the pump 38 (the motor M) is activated to supply the brake fluid in the reservoir 40 to the hydraulic circuit 33. Subsequently, the operation of the proportional differential pressure valve 52 is controlled based on the total instruction hydraulic pressure PI. Then, the brake fluid pressure in the right-front-wheel path 33a (the wheel cylinder 36a) is increased to the total instruction hydraulic pressure PI.

As a result, the brake fluid pressure in the right-front-wheel path 33a (the wheel cylinder 36a) is optimized for the slip amount SLP of the right front wheel FR and the rate of change of the slip amount SLP (the slip amount differentiated value DSLP). Thus, the acceleration slip of the right front wheel (drive wheel) FR is reliably suppressed.

The preferred embodiment has the following advantages.

(1) When the slip amount SLP of the front wheels (drive wheels) FR, FL is greater than the slip amount threshold value KSLP, the brake fluid pressure in the hydraulic circuit 33, 34 is changed in accordance with changes in the slip amount SLP of the front wheels FR, FL, and the front wheels FR, FL receive braking force the magnitude of which corresponds to the control amount of the brake fluid pressure (the total instruction hydraulic pressure PI). Further, when the slip amount SLP of the front wheels FR, FL falls to or below the slip amount threshold value KSLP, the brake fluid pressure in the hydraulic circuits 33, 34 is minimized. The front wheels FR, FL therefore hardly receive braking force. That is, the brake fluid pressure in the hydraulic circuits 33, 34 is changed to appropriately reflect changes in the slip amount SLP of the front wheels FR, FL.

(2) The first instruction hydraulic pressure PI1 is computed based on the slip amount SLP of the front wheels (drive wheels) FR, FL, and the second instruction hydraulic pressure PI2 is computed based on the rate of change of the slip amount SLP of the front wheels FR, FL (the slip amount differentiated value DSLP). The total instruction hydraulic pressure PI is obtained by adding the first instruction hydraulic pressure PI1 to the second instruction hydraulic pressure PI2. Based on the total instruction hydraulic pressure PI, braking force is applied the front wheels FR, FL. That is, when the brake fluid pressure needs to be increased, the brake fluid pressure can be set high, and when the brake fluid pressure does not need to be increased, the brake fluid pressure can be set low.

The above described embodiment may be changed as the following further embodiments (modified embodiments).

When advancing the timing at which the total instruction hydraulic pressure PI is increased, the second constant Kb for computing the second instruction hydraulic pressure PI2 may be set to a greater value. On the other hand, when retarding the timing at which the total instruction hydraulic pressure PI is increased, the first constant Ka for computing the first instruction hydraulic pressure PI1 may be set to a greater value.

In the illustrated embodiment, the first instruction hydraulic pressure PI1 is not necessarily computed. In this case, since the total instruction hydraulic pressure PI is equal to the second instruction hydraulic pressure PI2, the total instruction hydraulic pressure PI changes at the timing shown by the alternate long and short dash line in FIG. 4B. In this case, if the rate of change of the slip amount SLP of the front wheels FR, FL (the slip amount differentiated value DSLP) is high, the braking force applied to the front wheels FR, FL is increased. Also, when the rate of change is low (including the case of a negative value of the rate of change), the braking force applied to the front wheels FR, FL is reduced. That is, when the front wheels FR, FL start acceleration slip, a great braking force is applied to the front wheels FR, FL. Thus, the acceleration slip of the front wheels FR, FL is reliably suppressed.

In the illustrated embodiment, the second instruction hydraulic pressure PI2 is not necessarily computed. In this case, since the total instruction hydraulic pressure PI is equal to the first instruction hydraulic pressure PI1, the total instruction hydraulic pressure PI changes at the timing shown by the solid line in FIG. 4B. In this case, the brake fluid pressure in the hydraulic circuits 33, 34 changes at the same timing at which the slip amount SLP of the front wheels FR, FL changes. Therefore, when the slip amount SLP of the front wheels FR, FL is increasing, the braking force applied to the front wheels FR, FL is increased. When the slip amount SLP of the front wheels FR, FL is decreasing, the braking force applied to the front wheels FR, FL is decreased.

In the illustrated embodiment, the slip amount threshold value KSLP may be any value (for example, zero).

In the illustrated embodiment, the present invention is applied to the traction control apparatus 11 mounted on a front-wheel drive vehicle. However, the present invention may be applied to a traction control apparatus mounted on a rear-wheel drive vehicle. Alternatively, the present invention may be applied to a traction control apparatus mounted on a four-wheel drive vehicle.

In the illustrated embodiment, the circuit configuration may be modified such that the first hydraulic circuit 33 is connected to the wheel cylinder 36a for the right front wheel FR and the wheel cylinder 36b for the left front wheel FL, and the second hydraulic circuit 34 is connected to the wheel cylinder 36c for the right rear wheel RR and the wheel cylinder 36d for the left rear wheel RL.

1. A traction control apparatus for a vehicle that has a drive wheel, the apparatus comprising:
a hydraulic circuit;
a hydraulic pressure changing unit for changing a brake fluid pressure in the hydraulic circuit;
a braking unit for applying a braking force to the drive wheel based on the brake fluid pressure in the hydraulic circuit changed by the hydraulic pressure changing unit;
a slip amount detection unit for detecting a slip amount of the drive wheel;
a control amount computing unit, wherein the control amount computing unit computes a control amount for changing the brake fluid pressure in the hydraulic circuit such that, during a period from when the slip amount of the drive wheel detected by the slip amount detection unit surpasses a predetermined slip amount threshold value to when the slip amount falls to or below the slip amount threshold value, the brake fluid pressure reaches a maximum pressure corresponding to the slip amount and thereafter falls from the maximum pressure to a minimum pressure; and
a control unit for controlling the hydraulic pressure changing unit based on the control amount computed by the control amount computing unit.

2. The apparatus according to claim 1, wherein the control amount is computed by multiplying the slip amount of the drive wheel detected by the slip amount detection unit by a slip amount constant, and is proportionate to the magnitude of the slip amount.

3. The apparatus according to claim 1, wherein the control amount is computed by multiplying a slip amount differentiated value, which is obtained by differentiating the slip amount of the drive wheel detected by the slip amount detection unit, by a slip amount differentiated value constant, and is proportionate to the rate of change of the slip amount.

4. The apparatus according to claim 1, wherein the control amount is the sum of a first control amount and a second control amount, wherein the first control amount is computed by multiplying the slip amount of the drive wheel detected by the slip amount detection unit by a slip amount constant, and is proportionate to the magnitude of the slip amount, and wherein the second control amount is computed by multiplying a slip amount differentiated value, which is obtained by differentiating the slip amount of the drive wheel detected by the slip amount detection unit, by a slip amount differentiated value constant, and is proportionate to the rate of change of the slip amount.

5. A traction control method for a vehicle that has a drive wheel, the method comprising:
detecting a slip amount of the drive wheel;
changing a brake fluid pressure in a hydraulic circuit such that, during a period from when the detected slip amount of the drive wheel surpasses a predetermined slip amount threshold value to when the slip amount falls to or below the slip amount threshold value, the brake fluid pressure reaches a maximum pressure corresponding to the slip amount and thereafter falls from the maximum pressure to a minimum pressure; and
applying a braking force to the drive wheel based on the changed brake fluid pressure in the hydraulic circuit.

6. The method according to claim 5, wherein the brake fluid pressure in the hydraulic circuit is changed based on a control amount, wherein the control amount is computed by multiplying the detected slip amount of the drive wheel by a slip amount constant, and is proportionate to the magnitude of the slip amount.

7. The method according to claim 5, wherein the brake fluid pressure in the hydraulic circuit is changed based on a control amount, wherein the control amount is computed by multiplying a slip amount differentiated value, which is obtained by differentiating the detected slip amount of the drive wheel, by a slip amount differentiated value constant, and is proportionate to the rate of change of the slip amount.

8. The method according to claim 5, wherein the brake fluid pressure in the hydraulic circuit is changed based on a control amount that is the sum of a first control amount and a second control amount, wherein the first control amount is computed by multiplying the detected slip amount of the drive wheel by a slip amount constant, and is proportionate to the magnitude of the slip amount, and wherein the second control amount is computed by multiplying a slip amount differentiated value, which is obtained by differentiating the detected slip amount of the drive wheel, by a slip amount differentiated value constant, and is proportionate to the rate of change of the slip amount.
